(19) United States
(12) Patent Application Publication
(10) Pub. No.: US 2016/0324303 A1
(43) Pub. Date: Nov. 10, 2016

(54) ARMBAND FOR HOLDING A RANGEFINDER

(71) Applicant: Thomas Mudge, Bountiful, UT (US)

(72) Inventor: Thomas Mudge, Bountiful, UT (US)

(21) Appl. No.: 15/148,966

(22) Filed: May 6, 2016

Related U.S. Application Data
(60) Provisional application No. 62/157,864, filed on May 6, 2015.

(51) Int. Cl. A45F 5/00; G01C 3/08; B65H 75/44; A45C 11/08; B65H 75/40

(52) U.S. Cl. CPC A45F 5/004; A45C 11/08; B65H 75/40; B65H 75/4471; G01C 3/08; A45F 2005/008; B65H 2701/35

(57) ABSTRACT

Apparatuses, systems, and methods are disclosed for securing a rangefinder to a user's arm. In one embodiment, an armband is sized to encircle a user's arm. In a certain embodiment, a receptacle is sized to receive a rangefinder. In a further embodiment, the receptacle is coupled to the armband. In one embodiment, a cord couples the rangefinder to the armband.

### CROSS-REFERENCES TO RELATED APPLICATIONS

This application claims the benefit of U.S. Provisional Patent Application No. 62/157,864 entitled “ARMBAND FOR HOLDING A RANGEFINDER” and filed on May 6, 2015 for Thomas Mudge, which is incorporated herein by reference.

### FIELD

The present disclosure, in various embodiments, relates to using a rangefinder and more particularly relates to securing a rangefinder to a user's arm.

### BACKGROUND

Various people, such as hunters, may use binoculars to view a distant object and may use a rangefinder to measure the distance to the object. A lanyard may be attached to a rangefinder or a pair of binoculars, and worn around the neck for convenient access. However, when both a rangefinder and a pair of binoculars are used, wearing both devices around the neck may result in the devices colliding when the user moves, which may cause unnecessary noise, or may damage either device.

### SUMMARY

Apparatuses are disclosed for securing a rangefinder to a user's arm. In one embodiment, an armband is sized to encircle a user's arm. In a certain embodiment, a receptacle is sized to receive a rangefinder. In a further embodiment, the receptacle is coupled to the armband. In some embodiments, a cord couples the rangefinder to the armband.

In one embodiment, the receptacle is non-detachably coupled to the armband. In a further embodiment, the cord extends to the rangefinder from the receptacle and/or the armband. In another embodiment, the receptacle is detachably coupled to the armband. In a further embodiment, the cord extends from the armband to the receptacle and/or the rangefinder. In some embodiments, a magnetic fastener removably fastens the receptacle adjacent to the armband.

In one embodiment, the cord is a retractable cord. In a further embodiment, a cord reel retracts and stores the cord. In another embodiment, the cord is an elastic cord. In a certain embodiment, a length of the cord is selected to extend from the user's arm to the user's face, such that the rangefinder is usable with the cord attached. In a further embodiment, the length of the cord is selected to prevent the rangefinder from falling to the ground.

In one embodiment, the armband and/or the receptacle may include a pocket. In a certain embodiment, the armband may include a strap for encircling the user's arm. In another embodiment, the armband may include a sleeve sized to cover at least part of the user's lower and upper arm. In a further embodiment, a lower portion of the sleeve may include an arm guard.

Systems are disclosed for securing a rangefinder to a user's arm. In one embodiment, a system includes a rangefinder. In various embodiments, an armband is sized to encircle a user's arm. In a certain embodiment, a receptacle is sized to receive the rangefinder. In a further embodiment, the receptacle is coupled to the armband. In some embodiments, a cord couples the rangefinder to the armband.

In one embodiment, the receptacle is non-detachably coupled to the armband. In a further embodiment, the cord extends to the rangefinder from the receptacle and/or the armband. In another embodiment, the receptacle is detachably coupled to the armband. In a further embodiment, the cord extends from the armband to the receptacle and/or the rangefinder. In some embodiments, a magnetic fastener removably fastens the receptacle adjacent to the armband.

In one embodiment, the cord is a retractable cord. In a further embodiment, a cord reel retracts and stores the cord. In another embodiment, the cord is an elastic cord. In a certain embodiment, a length of the cord is selected to extend from the user's arm to the user's face, such that the rangefinder is usable with the cord attached.

An apparatus for securing a rangefinder to a user's arm, in another embodiment, includes a sleeve sized to encircle at least part of a user's lower and upper arm. In a certain embodiment, a receptacle is sized to receive a rangefinder. In a further embodiment, the receptacle is non-detachably coupled to the sleeve. In some embodiments, a retractable cord couples the rangefinder to the sleeve. In further embodiments, the cord extends from the sleeve and/or the receptacle to the rangefinder. In one embodiment, a length of the cord is selected to prevent the rangefinder from falling to the ground and to extend from the user's arm to the user's face, such that the rangefinder is usable with the cord attached. In a certain embodiment, a cord reel retracts and stores the cord. In a further embodiment, an arm guard is coupled to a lower portion of the sleeve. In some embodiments, the sleeve and/or the receptacle may include a pocket.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of an apparatus for securing a rangefinder to a user's arm, with the rangefinder secured;

FIG. 2 is a front view further illustrating the apparatus of FIG. 1, with the rangefinder in use;

FIG. 3 is a side view illustrating one embodiment of a rangefinder;

FIG. 4 is a side view illustrating one embodiment of a receptacle for a rangefinder;

FIG. 5 is a side view illustrating another embodiment of a receptacle for a rangefinder;

FIG. 6 is a side view illustrating one embodiment of an armband;

FIG. 7 is a side view illustrating the reverse side of the armband of FIG. 6; and

FIG. 8 is a perspective view illustrating another embodiment of an apparatus for securing a rangefinder to a user's arm.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Applicant recognizes that securing a rangefinder to a user's arm may provide convenient access to the rangefinder, while also avoiding collisions with binoculars or other devices. Although some of the embodiments of the apparatus disclosed herein have been described as being operable to secure a rangefinder to a user's arm, it is recognized that certain embodiments of the present invention may also be operable with devices other than rangefinders, and may also be capable of securing a rangefinder or other device to a limb or another object other than a user's arm. For example, one embodiment of the apparatus described herein may be used with binoculars instead of a rangefinder.

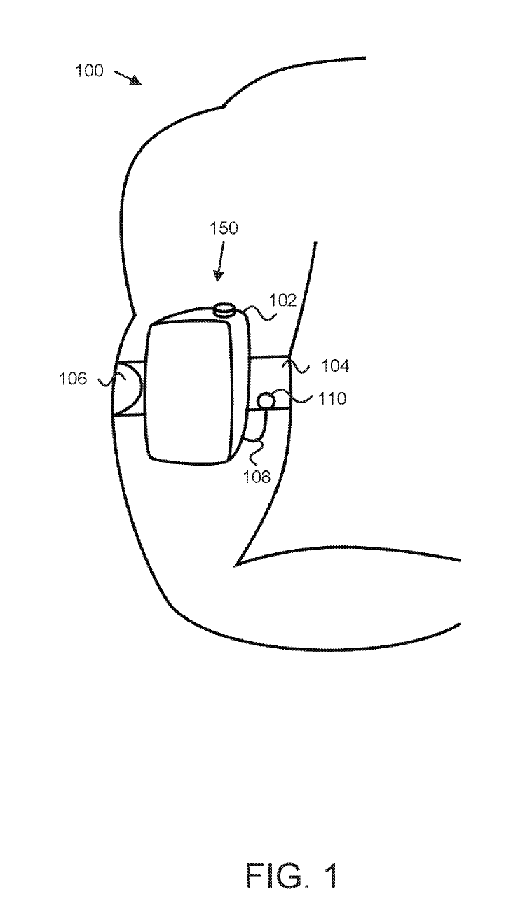

FIG. 1 depicts one embodiment of an apparatus 100 for securing a rangefinder 150 to a user's arm. In the depicted embodiment, the apparatus 100 may include a receptacle 102 for the rangefinder 150, and an armband 104. In certain embodiments, the apparatus 100 includes a closure 106 for the armband 104, a cord 108 that extends from the armband 104 to the receptacle 102, and a reinforced area 110 of the armband 104. In another embodiment, however, an apparatus 100 may include the receptacle 102 and armband 104, and may omit a closure 106, a cord 108, and/or a reinforced area 110. In the depicted embodiment, the apparatus 100 for securing a rangefinder 150 does not include the rangefinder 150, but is depicted with the rangefinder 150 to show the apparatus 100 in use. In another embodiment, a system for securing a rangefinder 150 may include the rangefinder 150. In general, in various embodiments, a receptacle 102 may hold or receive a rangefinder 150, the armband 104 may be secured to a user's arm, and a cord 108 may couple the rangefinder 150 to the armband 104, so that the rangefinder 150 is secured to the user's arm. Securing a rangefinder 150 to a user's arm, in various embodiments, may keep the rangefinder 150 away from other objects that may damage the rangefinder 150, such as a pair of binoculars on a lanyard, but may provide convenient access to the rangefinder 150. In one embodiment, the receptacle 102 may provide access to the rangefinder 150 without opening and/or closing a case.

In the depicted embodiment, the receptacle 102 holds, receives, or is coupled to the rangefinder 150. In various embodiments, the receptacle 102 may be sized and/or shaped to receive a rangefinder 150. For example, in one embodiment, the receptacle 102 may be sized to closely fit a particular model or type of rangefinder 150. In another embodiment, the receptacle 102 may be sized to approximately fit multiple models or types of rangefinder 150. In a certain embodiment, the receptacle 102 may be elastic, adjustable, or the like to fit or receive various rangefinder 150.

In various embodiments, the apparatus 100 may include various forms of receptacles 102. For example, in one embodiment, the receptacle 102 may be a pouch or pocket with an opening at one end to receive the rangefinder 150. A pouch may be formed of fabric (e.g., polyester, nylon, canvas, wool, cotton, or the like), leather, a plastic/polymer, or the like. In one embodiment, the receptacle 102 may be expanded elastically to admit or receive a rangefinder 150 and may be tight enough to removably hold the rangefinder 150 with a friction hold, so that the rangefinder 150 doesn't inadvertently fall out of the receptacle 102. In another embodiment, the opening of a receptacle 102 may be closed with a flap, button, snap, hook-and-loop fastener or the like, to secure a rangefinder 150.

In another embodiment, a receptacle 102 may be a sleeve, band, loop, wrapper, covering, or the like that is sized to encircle the rangefinder 150. In one embodiment, the receptacle 102 may be an elastic sleeve that opens to admit the rangefinder 150 and hold it snugly. For example, in various embodiments, the receptacle 102 may be made of lycra, rubber, neoprene, or another elastic material. In another embodiment, the receptacle 102 may be a sheet or band that wraps around the rangefinder 150 and is fastened in a closed position to form a sleeve. For example, in one embodiment, the receptacle 102 may be a sheet or band with hook-and-loop (e.g., Velcro®) fasteners enabling the sheet or band to be fastened around the rangefinder 150. In one embodiment the receptacle 102 may be at least partially open at both ends so as not to obscure the optics of the rangefinder 150.

In another embodiment, a receptacle 102 may include a rigid cradle, formed of a durable material such as a metal, a plastic or polymer, or the like, shaped to receive the rangefinder 150. In various embodiments, a cradle type receptacle 102 may include a hook, a rigid loop, a rigid pocket, or the like. In a certain embodiment, a receptacle 102 may include a cradle that flexes sufficiently for a user to snap the rangefinder 102 into or out of the receptacle 102. In another embodiment, a cradle-type receptacle 102 may stretch sufficiently for a user to insert or remove a rangefinder 102. A variety of possible forms of receptacle 102 for receiving a rangefinder 150, in various embodiments, are clear in view of this disclosure.

In the depicted embodiment, the armband 104 is secured to a user's arm. In certain embodiments, an armband 104 may refer to any band, loop, sleeve, or the like, that is configured to encircle a user's arm.

In various embodiments, an armband 104 may be sized to encircle a user's arm. For example, in one embodiment, the armband 104 may be an elastic (e.g., lycra, neoprene, or the like) loop, sized to fit a user's arm. In certain embodiments, an elastic armband 104 may accommodate a variety of arm sizes. In another embodiment, the armband 104 may be a strap with an adjustable closure 106, and may accommodate a variety of arm sizes by adjusting the closure 106.

In various embodiments, the armband 104 may have various widths. Thus, in certain embodiments, a band, loop, sleeve, or the like, that is configured to encircle a user's arm may be referred to as an armband 104 regardless of width. For example, in some embodiments, an armband 104 may include a narrow loop, a wider band, a partial sleeve, a full sleeve, or the like. In one embodiment, a width of the armband 104 may be approximately three inches. In another embodiment, the armband 104 may be a sleeve that covers a significant portion of the user's arm. For example, in one embodiment, a sleeve may cover at least part of a user's upper and lower arm. In certain embodiments, an elastic sleeve made of lycra or a similar material may snugly fit a user's arm. In a further embodiment, a lower portion of the armband may include an arm guard for protecting the user's forearm from being injured by a bow string or arrow fletching. For example, in one embodiment, the armband 104 may be a full sleeve, and an archery arm guard made of leather, plastic, padded fabric, or the like, may be sewn into (or otherwise attached to) the forearm portion of the sleeve.

In the depicted embodiment, the armband 104 is a strap, and a closure 106 fastens the armband 104 around the user's arm. In another embodiment, as described above, the armband 104 may be a closed loop without a closure 106. In one embodiment, the closure 106 may be adjustable so that a user can change the circumference of the armband 104 to fit his or her arm. For example, in one embodiment, the closure 106 may be a hook-and-loop (e.g., Velcro®) fastener that can be fastened in a range of different positions. In another embodiment, the closure 106 may be a buckle, and the armband 106 strap may be pulled through the buckle to adjust the fit. In another embodiment, the closure 106 may be a non-adjustable fastener, and elastic material in the armband 104 may accommodate different arm sizes. Various types of fasteners suitable for use as a closure 106 for an armband 104 will be clear in view of this disclosure.

In various embodiments, the receptacle 102 is coupled to the armband 104. A receptacle 102 may be referred to as detachably coupled to the armband 104 if a user can reasonably detach the receptacle 102 from the armband 104 while wearing the armband, and may be referred to as non-detachably coupled to the armband 104 otherwise, even if it is technically possible to detach the receptacle 102 from the armband 104 (e.g., by unpicking seams or the like). In one embodiment, the receptacle 102 may be non-detachably coupled to the armband 104. For example, in various embodiments the receptacle 102 may be sewn, glued, or otherwise permanently or semi-permanently affixed to the armband 104, and the rangefinder 150 may be removed from the receptacle 102 for use. In another embodiment, the receptacle 102 may be detachably coupled to the armband 104. For example, in various embodiments, the receptacle 102 may be fastened to the armband 104 using a magnetic fastener, a hook-and-loop fastener, or the like, and may be detached from the armband 104 to use the rangefinder 150. (In certain embodiments, the rangefinder 150 may be used while in the receptacle 102.)

In the depicted embodiment, a cord 108 couples the rangefinder 150 to the armband 104. In one embodiment, a cord 108 may couple the rangefinder 150 to the armband 104 directly, by extending between the rangefinder 150 and the armband 104. In another embodiment, the cord 108 may couple the rangefinder 150 to the armband 104 indirectly via the receptacle 102 or another object coupled to the armband 104 and/or the rangefinder 150. In a certain embodiment, where the receptacle 102 is non-detachably coupled to the armband 104, the cord 108 may extend to the rangefinder from the receptacle 102 and/or the armband 104. In a further embodiment, the cord 108 may extend from the armband 104 or receptacle 102 directly to the rangefinder 150. For example, the cord 108 may attach to the rangefinder 150 at an attachment point for a lanyard. In another embodiment, where the receptacle 102 is detachably coupled to the armband 104, the cord 108 may extend from the armband 104 to the receptacle 102 and/or the rangefinder 150. For example, one end of the cord 108 may be attached to the armband 104, and the other end of the cord 108 may be attached to the rangefinder 150 at an attachment point for a lanyard, or may be attached to the receptacle 102, with the rangefinder 150 in the receptacle 102.

In certain embodiments, the rangefinder 150 and the receptacle 102 may be fastened to the armband 104 to secure the rangefinder 150, or unfastened from the armband 104 to use the rangefinder 150. In a further embodiment, if the rangefinder 150 is dropped while unfastened, or if the rangefinder 150 and receptacle 102 are inadvertently unfastened from the armband 104 by a snag, a hard impact, or the like, a cord 108 that couples the rangefinder 150 to the armband 104 may prevent the rangefinder 150 from falling to the ground and becoming damaged.

In some embodiments, the cord 108 may be a shock cord, a parachute cord, or the like. In certain embodiments, the cord 108 may be a retractable cord. For example, in one embodiment, the cord 108 may retract into a cord reel coupled to the armband 104 or the receptacle 102. In a further embodiment, the cord reel may retract and store the cord 108. For example, a cord reel may be spring-loaded so that a user can pull the cord 108 from the reel to use the rangefinder 150, and so that the cord 150 is automatically rewound onto the cord reel when the rangefinder 150 is released. In another embodiment, the cord 108 may be an elastic cord that a user stretches when the rangefinder 150 is in use, and that contracts when the rangefinder 150 is released. In certain embodiments, an elastic or retractable cord 108 may be less prone to being fouled or snagged than a non-elastic or non-retractable cord 108.

In various embodiments, the length of the cord 108 may be selected to extend from the user's arm (e.g., from the armband 104 or from the receptacle 102 positioned on the armband 104) to the user's face, or to a point near the user's face, so that the rangefinder 150 can be used with the cord 108 attached. In certain embodiments, where the cord 108 is elastic or retractable, the length of the cord 108 may refer to a stretched or extended length. In a further embodiment, the length of the cord 108 may be further selected to prevent the rangefinder 150 from falling to the ground. For example, a longer cord 108 may be selected for a large or tall user, to facilitate use of the rangefinder 150 while still preventing the rangefinder 150 from falling to the ground. Conversely, in another embodiment, a shorter cord 108 may be selected for a small or short user. In various embodiments, the length of the cord 108 may be selected by a user, a manufacturer of the apparatus 100, or the like. For example, in one embodiment, a manufacturer of the apparatus 100 may select the length of the cord 108, and provide one cord 108 of the selected length. In another embodiment, a user may select a cord 108 from a plurality of cords of various lengths, or may shorten a cord 108 by cutting or tying the cord 108. Various types and lengths of cord 108 suitable for preventing a rangefinder 108 from being damaged if dropped will be clear in view of this disclosure.

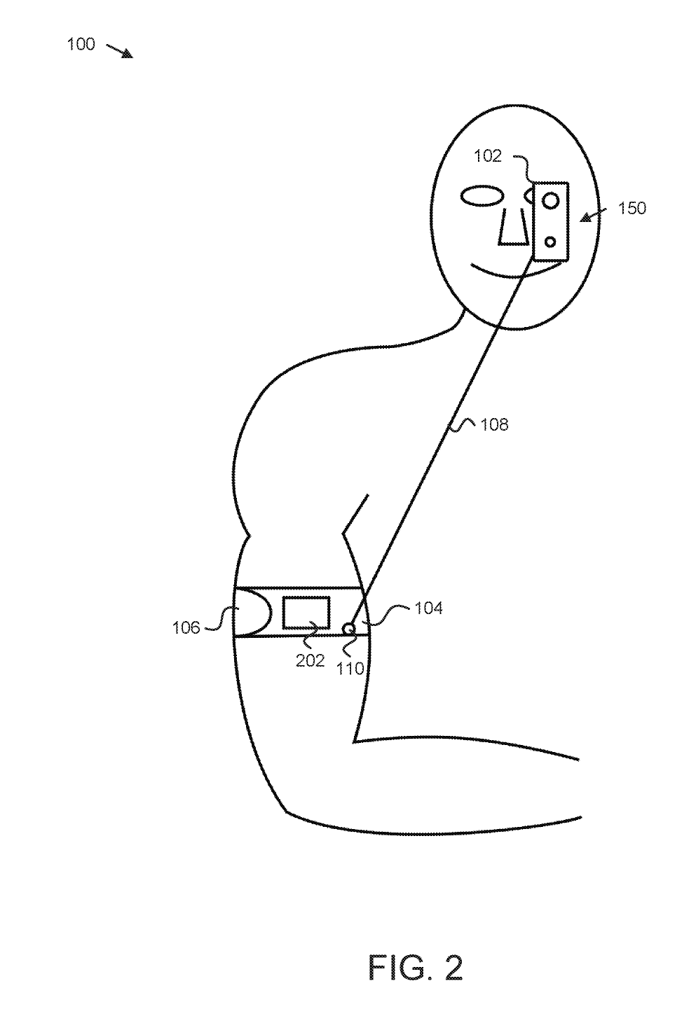

In one embodiment, the apparatus 100 may include one or more reinforced areas 110 or portions, at one or both ends of the cord 108. For example, in the depicted embodiment, the cord 108 connects to a reinforced area 110 of the armband 104. Similarly, in another embodiment, an end of the cord 108 may connect to a reinforced area 110 of the receptacle 102. In various embodiments, coupling the cord 108 to reinforced areas 110 of the armband 104 or receptacle 102 may prevent the armband 104 or receptacle 102 from tearing or otherwise being damaged by tension on the cord 108. In various embodiments, a reinforced area 110 may include a grommet, a fabric patch, a thicker material than other portions of the armband 104 or receptacle 102, or the like. Various ways of reinforcing an area are clear in view of this disclosure. FIG. 2 depicts the apparatus 100 of FIG. 1, with the rangefinder 150 in use. The receptacle 102, armband 104, closure 106, cord 108, and reinforced area 110 may be substantially as described above with regard to FIG. 1. In the depicted embodiment, the apparatus 100 includes a fastener 202 which was not visible in FIG. 1.

In the depicted embodiment, the fastener 202 removably fastens the receptacle 102 adjacent to the armband 104. Thus, in the fastened position (as depicted in FIG. 1), the fastener 202 secures the rangefinder 150 to the user's arm. With the fastener 202 unfastened (as depicted in FIG. 2), the rangefinder 150 can be brought to the user's eye for use.

In various embodiments, various types of fasteners 202 may be suitable for fastening the receptacle 102 adjacent to the armband 104, and suitable types of fasteners 202 will be clear in view of this disclosure. In one embodiment the fastener 202 allows a user to conveniently fasten or unfasten the receptacle 102 from the armband 104 with one hand, for convenient use of the rangefinder 150. For example, in one embodiment, a magnetic fastener 202 may include two magnets, or one magnet and a metallic plate, in corresponding positions on the receptacle 102 and the armband 104, so that a user may quickly and easily secure or use the rangefinder 150.

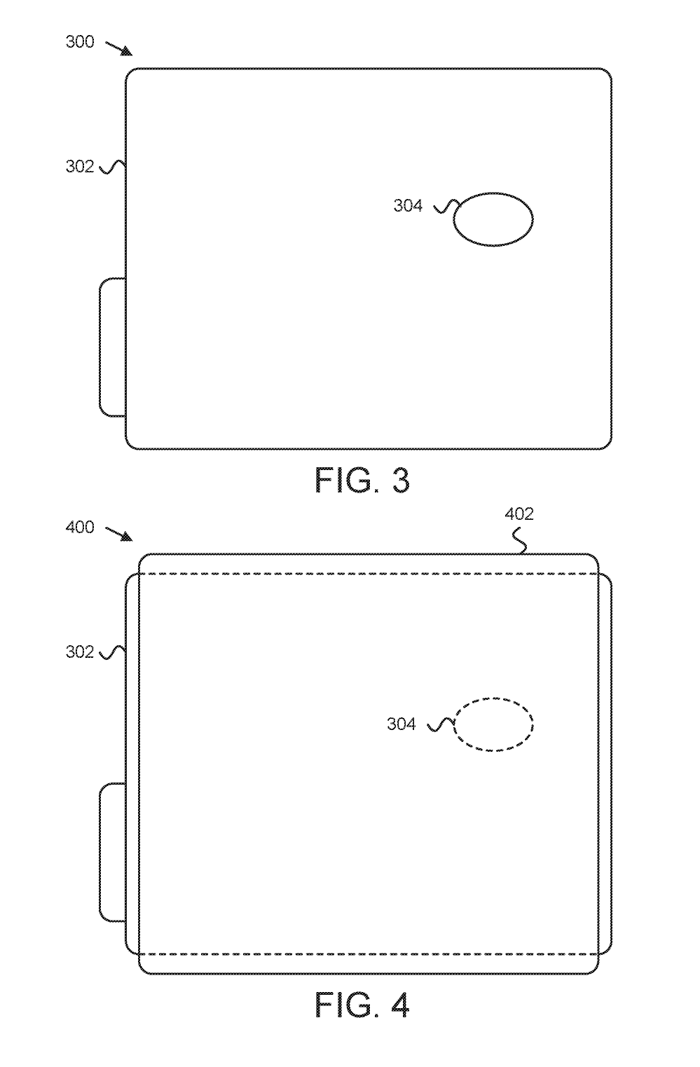

In another embodiment, a hook-and-loop (e.g., Velcro®) fastener 202 with the hook material on the armband 104 and the loop material on the receptacle 102 (or vice versa) may provide a similar level of convenience. In a further embodiment, the fastener 202 may comprise an elastic loop (e.g., rubber, an elastomer or other polymer, or the like) that removably holds the rangefinder 150 and the rangefinder sleeve 102 to the armband 104, stretching from the armband 104 around the rangefinder 150 and sleeve 102 until a user removes them from the elastic loop fastener 202. Various suitable fasteners 202 will be clear in view of this disclosure. FIG. 3 depicts one embodiment of a rangefinder 300, which may be substantially similar to the rangefinder 150 of FIGS. 1 and 2. In the depicted embodiment, the body 302 of the rangefinder encloses its optical and/or electronic components. One or more buttons 304 or other controls may allow a user to operate the rangefinder 300. In various embodiments, the rangefinder 300 may include a microwave, infrared or laser rangefinder, an ultrasonic rangefinder, a stereoscopic, parallax, or coincidence rangefinder, a stadiametric rangefinder, or the like. Various types of rangefinder 300 that may be used with an apparatus 100 for securing a rangefinder 300 will be clear in view of this disclosure.

FIG. 4 depicts one embodiment of a receptacle 400, which may be substantially similar to the receptacle 102 of FIGS. 1 and 2. In the depicted embodiment, the receptacle 400 is in use with the rangefinder 300 of FIG. 3. In one embodiment, the receptacle 400 comprises a band 402 of elastic material, such as lycra, neoprene, or the like, that encircles the body 302 of the rangefinder 300. In the depicted embodiment, the band 402 has open ends so as not to obscure the optics of the rangefinder 300. In a further embodiment, the material of the band 402 may be sufficiently thin for a user to feel and operate one or more buttons 304 or other controls for the rangefinder 300, through the band 402. In another embodiment, the band 402 may include an opening for a button 304 on the rangefinder 300. In the depicted embodiment, the receptacle 400 is sized to cover nearly the entire rangefinder 300. In another embodiment, however, the receptacle 400 may be smaller, and may securely hold the rangefinder 300 while leaving additional surfaces of the rangefinder 300 uncovered.

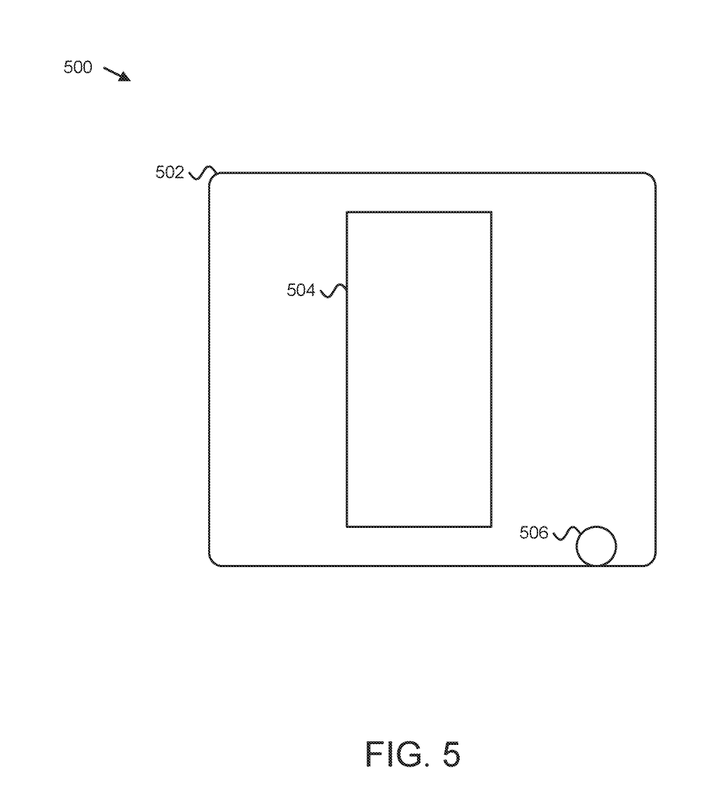

FIG. 5 depicts another embodiment of a receptacle 500, similar to the receptacle 102 of FIGS. 1 and 2, or the receptacle 400 of FIG. 4. In the depicted embodiment, the receptacle 500 includes a body 502 or band, similar to the band 402 of FIG. 4, that is sized to encircle a rangefinder, as described above. The body 502 of the receptacle 500 is depicted substantially straight lines in FIG. 5 for convenience in depiction, but the depicted lines are not intended to imply rigidity. In one embodiment, the body 502 of a receptacle 500 may be made of a rigid material, to closely fit a particular rangefinder. In certain other embodiments, however, the body 502 of the receptacle 500 may be made of a flexible or elastic material, which may accommodate a variety of different rangefinders.

In the depicted embodiment, the receptacle 500 includes a magnetic or metallic plate 504, and a reinforced portion 506. In one embodiment, the magnetic or metallic place 504 acts as a fastener, in combination with a corresponding magnet or metallic plate in the armband, to fasten the receptacle 500 to the armband as described above. In certain embodiments, a reinforced portion 506 of the receptacle 500 provides an attachment point for a cord, such as the cord 108 of FIGS. 1 and 2, that prevents a rangefinder from falling to the ground. For example, in various embodiments, the reinforced portion 506 may surround an opening that the cord attaches to, and may be reinforced to prevent the cord from tearing the opening. In various embodiments, a reinforced portion 506 may include a grommet, a second layer of additional fabric, or the like. Various ways of reinforcing a portion 506 of a receptacle 500 where a cord attaches are clear in view of this disclosure.

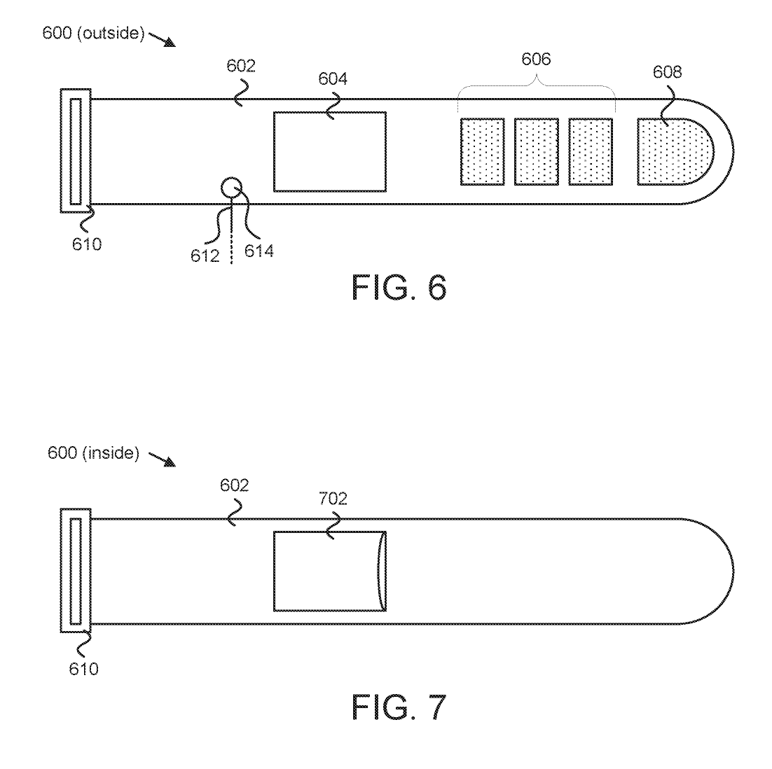

FIGS. 6 and 7 depict one embodiment of an armband 600, which may be substantially similar to the armband 104 of FIGS. 1 and 2. FIG. 6 depicts the outside of the armband 600, as worn on a user's arm, and FIG. 7 depicts the reverse, or inside of the armband 600. In the depicted embodiment, the armband 600 includes a strap 602 for encircling the user's arm, and a loop 610. In the depicted embodiment, a magnetic or metallic plate 604, hook-and-loop fasteners 606, 608, and a cord reel 614 are attached to the outside of the armband 600; a retractable cord 612, similar to the cord 108 of FIGS. 1 and 2 extends from the cord reel 614. In the depicted embodiment, a pocket 702 is attached to the inside of the armband 600.

In various embodiments, the strap 602 may be made of various materials. In one embodiment, the strap 602 may be made of an elastic material such as lycra or neoprene. In another embodiment, the strap 602 may be made of a conventional fabric such as canvas, ballistic nylon, or the like. Many types of materials suitable for an armband 600 for securing a rangefinder to a user's arm will be clear in light of this disclosure. In general, the armband 600 may be worn by wrapping the strap 602 around a user's arm, passing one end of the strap 602 through a loop 610 at or near the other end of the strap 602, then folding the first end of the strap 602 back over the loop 610, to fasten to itself.

In the depicted embodiment, the loop 610 is attached to one end of the strap 602. For example, in one embodiment, an end of the strap 602 may be wrapped around one edge of a loop 610 and sewn to itself to attach the strap 602 to the loop 610. In a certain embodiment, the loop may be made of metal, plastic, or the like. In another embodiment, the loop 610 may be an opening formed in one end of the strap 602. For example, in a further embodiment, a slit or narrow opening may be cut across one end of the strap 602 to form the loop 610, which may be reinforced to avoid tearing. Various ways of forming or attaching a loop 610 are clear in view of this disclosure.

In the depicted embodiment, a magnetic or metallic plate 604 is attached to the strap 602. As described above with regard to FIG. 5, the magnetic or metallic plate 604 may act as a fastener in combination with a corresponding magnetic or metallic plate in the receptacle, thus allowing a user to quickly attach the receptacle to (or remove it from) the armband 600. In various embodiments, the metallic or magnetic plate 604 may be attached to the strap 602 by an adhesive, disposed under a layer of fabric that is sewn to the strap 602, or the like. Various ways of attaching a magnetic or metallic plate 604 to a strap 602 will be clear in view of this disclosure.

In another embodiment, a receptacle for the rangefinder may be attached directly to the strap 602, by sewing, gluing, or the like, rather than by use of a magnetic or metallic plate 604. In one embodiment, a width of the strap 602 may be selected such that the receptacle for the rangefinder does not extend beyond the upper or lower edges of the strap 602. In another embodiment, an apparatus for securing a rangefinder may include a second armband, which may be substantially similar to the armband 600, and the receptacle may extend between the armband 600 and the second armband. In one embodiment, an apparatus including two armbands may allow a user to adjust the armbands to different sizes (e.g., to accommodate large biceps).

In the depicted embodiment, the armband 600 includes hook-and-loop (e.g., Velcro®) fasteners 606, 608. In one embodiments, one type of hook-and-loop fastener material 606 is disposed along a portion of the strap 602, and the corresponding type of hook-and-loop fastener material 608 is disposed at or near the end of the strap 602. For example, in one embodiment, the loop material 606 may be disposed at a few positions along the strap 602, and corresponding hook material 608 may be disposed at the end of the strap 602, or vice versa. The end of the strap 602 with the hook material 608 may be passed through the loop 610 and folded over the loop to fasten to the loop material 606 at some position along the strap 602. Thus, the hook-and-loop fastener 606, 608 may act as a closure for the armband 600, similar to the closure 106 of FIGS. 1 and 2. The closure may be adjusted to change the circumference of the armband 600 and accommodate different arm sizes by pulling more or less of the strap 602 through the loop. In certain embodiments, hook-and-loop fasteners 606, 608 at various positions along the strap 602 may facilitate adjusting the size of the armband 600.

In the depicted embodiment, a cord 612 extends from the armband 600 to a receptacle. The cord 612 may be substantially as described above with regard to the cord 108 of FIGS. 1 and 2. In one embodiment, a cord reel 614 is attached to the strap 602. In another embodiment, the cord reel 614 may be attached to the receptacle, and the cord 612 may extend to the strap 602. A cord reel 614 may retract the cord 612, and store the retractable cord 612 when the cord 612 is retracted. Various types of cord reels 614 for retractable cords 612 may be suitable for use with an armband 600.

In a certain embodiment, the armband 600 and/or the receptacle may include one or more pockets 702. For example, in one embodiment, a pocket 702 may be formed along or attached to the armband 600. In a further embodiment, a rectangular patch may be sewn to the armband 600 along three sides forming a pocket 702. In another embodiment, a receptacle may include a pocket in addition to or distinct from a portion of the receptacle that receives the rangefinder For example, in one embodiment, a receptacle may be a pouch, and a divider in the pouch may form a pocket and a portion for receiving the rangefinder. Various ways of forming or attaching a pocket 702 for the armband 600 or a receptacle will be clear in view of this disclosure. In some embodiments, a pocket 702 in the armband 600 or the receptacle may be a convenient place to carry documents such as an identification card, hunting license, or the like. In the depicted embodiment, the pocket 702 is disposed on the inside of the strap 602, as seen in FIG. 7. In another embodiment, however, a pocket 702 may be disposed along the outside of the strap, or on the inside or outside of the receptacle.

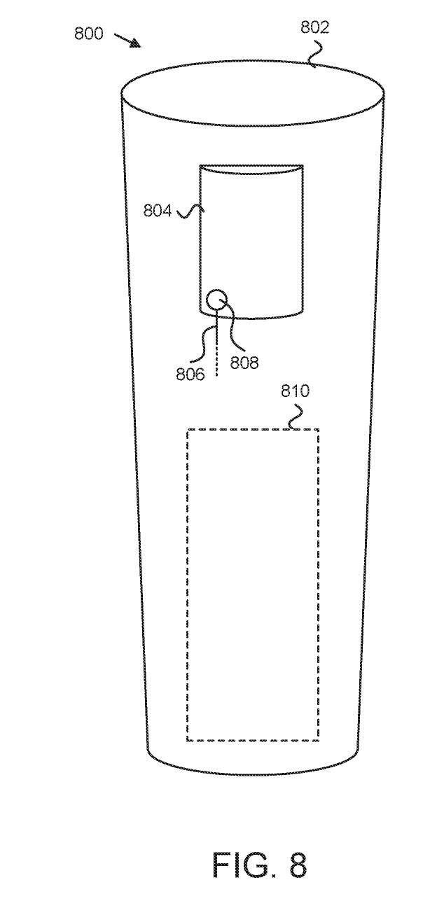

FIG. 8 depicts another embodiment of an apparatus 800 for securing a rangefinder to a user's arm. In various embodiments, the apparatus 800 may be substantially similar to the apparatus 100 described above with regard to FIGS. 1 and 2. In the depicted embodiment, the apparatus 800 includes a sleeve 802, a receptacle 804, a cord 806, a cord reel 808, and an arm guard 810. The receptacle 804, cord 806, and cord reel 808 may be substantially as described above. The sleeve 802 may be substantially similar to the armband described above with regard to FIGS. 1, 2, 6, and 7.

In addition, in the depicted embodiment, the sleeve 802 may be sized to cover or encircle at least part of the user's lower and upper arm. In one embodiment, the sleeve 802 may be made of an elastic material such as lycra or the like. In another embodiment, the sleeve 802 may be made of a conventional fabric such as canvas, ballistic nylon, or the like. In further embodiments, the sleeve 802 may stretch to fit a user's arm, or may include a closure substantially similar to the closure 106 described above with regard to FIGS. 1 and 2. Various materials suitable for forming a sleeve 802 will be clear in view of this disclosure. In a certain embodiment, the sleeve 802 may include a zipper or other fastener for attaching the sleeve 802 to a garment such as a jacket. For example, in one embodiment, a jacket may include detachable sleeves, and one sleeve for the jacket may be removed, and replaced with the sleeve 802.

In one embodiment, the receptacle 804 may be coupled to an upper portion of the sleeve 802. In various embodiments, coupling the receptacle 804 to an upper portion of the sleeve 802 may position a rangefinder adjacent to a user's upper arm for convenient access when the sleeve 802 is worn. In a further embodiment, a lower portion of the sleeve 802 comprises an arm guard 810, or an arm guard 810 is coupled or affixed to a lower portion of the sleeve 802. In various embodiments, an arm guard 810 included by or coupled to a lower portion of the sleeve 802 may be positioned adjacent to the user's forearm when the sleeve 802 is worn, to protect the user's forearm from being injured by a bow string or arrow fletching. For example, in one embodiment, an archery arm guard 810 made of leather, plastic, padded fabric, or the like, may be sewn into (or otherwise attached to) the forearm portion of the sleeve 802. In another embodiment the sleeve 802 or a portion thereof may be formed from a material that protects the arm, so that the sleeve 802 itself acts as the arm guard 810. In the depicted embodiment, the receptacle 804 and the arm guard 810 are positioned on opposite sides of the sleeve 802 (as indicated by the dashed line for the arm guard 810), so that the arm guard 810 protects an inner portion of the user's forearm, and so that the receptacle 804 secures a rangefinder adjacent to an outer portion of the user's arm. In certain embodiments, securing a rangefinder adjacent to an outer portion of the user's arm may provide convenient access to the rangefinder and may avoid positioning the rangefinder in a way that impairs the user's ability to move his or her arm. In another embodiment, however, the receptacle 804 may be in another position, relative to the arm guard 810, on the sleeve.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
an armband sized to encircle a user's arm;
a receptacle sized to receive a rangefinder, the receptacle coupled to the armband; and
a cord that couples the rangefinder to the armband.

2. The apparatus of claim 1, wherein the receptacle is non-detachably coupled to the armband, the cord extending to the rangefinder from one or more of the receptacle and the armband.

3. The apparatus of claim 1, wherein the receptacle is detachably coupled to the armband, the cord extending from the armband to one or more of the receptacle and the rangefinder.

4. The apparatus of claim 1, further comprising a magnetic fastener that removably fastens the receptacle adjacent to the armband.

5. The apparatus of claim 1, wherein the cord is a retractable cord, the apparatus further comprising a cord reel that retracts and stores the cord.

6. The apparatus of claim 1, wherein the cord is an elastic cord.

7. The apparatus of claim 1, wherein a length of the cord is selected to extend from the user's arm to the user's face, such that the rangefinder is usable with the cord attached.

8. The apparatus of claim 7, wherein the length of the cord is further selected to prevent the rangefinder from falling to the ground.

9. The apparatus of claim 1, wherein one or more of the armband and the receptacle comprises a pocket.

10. The apparatus of claim 1, wherein the armband comprises a strap for encircling the user's arm.

11. The apparatus of claim 1, wherein the armband comprises a sleeve sized to cover at least part of the user's lower and upper arm, wherein a lower portion of the sleeve comprises an arm guard.

12. A system comprising:
a rangefinder;
an armband sized to encircle a user's arm;
a receptacle sized to receive the rangefinder, the receptacle coupled to the armband; and
a cord that couples the rangefinder to the armband.

13. The system of claim 12, wherein the receptacle is non-detachably coupled to the armband, the cord extending to the rangefinder from one or more of the receptacle and the armband.

14. The system of claim 12, wherein the receptacle is detachably coupled to the armband, the cord extending from the armband to one or more of the receptacle and the rangefinder.

15. The system of claim 12, further comprising a magnetic fastener that removably fastens the receptacle adjacent to the armband.

16. The system of claim 12, wherein the cord is a retractable cord, the apparatus further comprising a cord reel that retracts and stores the cord.

17. The system of claim 12, wherein the cord is an elastic cord.

18. The system of claim 12, wherein a length of the cord is selected to extend from the user's arm to the user's face, such that the rangefinder is usable with the cord attached.

19. An apparatus comprising:
a sleeve sized to encircle at least part of a user's lower and upper arm;
a receptacle sized to receive a rangefinder, the receptacle non-detachably coupled to the sleeve;
a retractable cord that couples the rangefinder to the sleeve, the cord extending from one or more of the sleeve and the receptacle to the rangefinder, wherein a length of the cord is selected to prevent the rangefinder from falling to the ground and to extend from the user's arm to the user's face, such that the rangefinder is usable with the cord attached;
a cord reel that retracts and stores the cord; and
an arm guard coupled to a lower portion of the sleeve.

20. The apparatus of claim 19, wherein one or more of the sleeve and the receptacle comprises a pocket.
